(19) United States
(12) Patent Application Publication
(10) Pub. No.: US 2005/0083168 A1
(43) Pub. Date: Apr. 21, 2005

(54) Modular thermostat system

(76) Inventor: John Matthew Breitenbach, Hillsdale, NJ (US)

Correspondence Address: NEW URBAN MEDIA LLC, 400 VIEUX CARRE COURT, COLUMBIA, MO, 65203, US

(21) Appl. No.: 10/967,506

(22) Filed: Oct. 18, 2004

Related U.S. Application Data
(60) Provisional application No. 60/512,229, filed on Oct. 17, 2003.

(51) Int. Cl. H01H 37/04

(52) U.S. Cl. 337/380

(57) ABSTRACT

A facade system for concealing a thermostat housing including: a hinge being selectably positional in at least first and second positions; and, a cover adapted to be coupled to the hinge; wherein, when the hinge is positioned substantially adjacent to the thermostat housing and coupled to the cover, the hinge and cover cooperate to facilitate access to the thermostat housing when the hinge is in the first position and to substantially conceal the thermostat housing when the hinge is in the second position.

### RELATED APPLICATION

This Application claims the benefit of priority to copending U.S. Provisional Patent Application Ser. No. 60/512,229, entitled “MODULAR FASCIA THERMOSTAT SYSTEM”, filed Oct. 17, 2003, the entire disclosure of which is hereby incorporated by reference as if being set forth in its entirety herein.

### FIELD OF THE INVENTION

This invention relates generally to wall-mounted thermostats, and, more specifically, to a system that allows interchangeable front facades to be secured in a way that conceals a thermostat from view.

### BACKGROUND OF THE INVENTION

Typically, occupiers of space, such as homeowners or commercial or residential tenants, may want to hide a thermostat from view in order to make it blend in with a room's décor or prevent un-authorized use of it. Further exacerbating the situation, it may not be unusual for a typical room's décor to be in a state of flux, adapting to the then current desires of the resident or decorator. For example, it may not be unusual for some homeowners to change the décor of a room seasonally, such that the location and appearance of items fixed in or to a wall tend to limit or hinder the interior decorating and designing process.

Further, thermostats in tenant-occupied spaces are often a source of potential problems for landlords and property managers. Thermostats may frequently be the target of tampering and vandalism. While commercial guards are available for wall-mounted thermostats, they are often unsightly and, in some cases, may present more of an invitation for abuse because they make the thermostat more conspicuous. Also, such guards may serve to limit otherwise permitted use of a thermostat.

U.S. Pat. No. 5,810,193, the entire disclosure of which is hereby incorporated by reference as if being set forth in its entirety herein, shows a locking ornamental sconce for hiding a thermostat. However, this sconce does not provide adaptability, nor does it allow easy adjustment of the thermostat. It may also serve to undesirably require the sconce to be removed from the mounting bracket to make adjustments to the thermostat and have the effect of making the thermostat protrude significantly further into the space.

U.S. Pat. No. 5,485,954, the entire disclosure of which is hereby incorporated by reference as if being set forth in its entirety herein, describes a method of assembling circuit boards so that a thermostat may be installed with a reduced profile. The design described, however, leaves the thermostat in plain view and thus is not aesthetically adaptable.

U.S. Pat. No. 6,032,867, the entire disclosure of which is hereby incorporated by reference as if being set forth in its entirety herein, describes mounting of a thermostat inside the wall space in a standard electrical box in an attempt to make the thermostat protrude less into the room. Like other designs, however, this design also leaves the thermostat in plain view and does not provide for aesthetic adaptability.

Other approaches may include thermostats that work via a handheld remote control. In some circumstances a gain in aesthetic appearance by not having a thermostat mounted on the wall may be achieved. These thermostats, however, may not be suitable in many applications. Many of the problems associated with remote controls also plague these thermostat systems, including the inability to operate the thermostat if the remote is lost, broken, or the battery dies. Another complication with remote control systems is in commercial applications, there may be multiple personnel in charge of adjusting the thermostat, so a single remote may prove an impractical solution.

Thus, there is a need for a system that does not inhibit the functional attributes of a thermostat, while granting a homeowner or other space occupier the freedom to hide the unit in a way that can adapt to decorating tastes.

### SUMMARY OF THE INVENTION

A facade system for concealing a thermostat housing including: a hinge being selectably positional in at least first and second positions; and, a cover adapted to be coupled to the hinge; wherein, when the hinge is positioned substantially adjacent to the thermostat housing and coupled to the cover, the hinge and cover cooperate to facilitate access to the thermostat housing when the hinge is in the first position and to substantially conceal the thermostat housing when the hinge is in the second position.

### BRIEF DESCRIPTION OF THE DRAWING

Understanding of the present invention will be facilitated by consideration of the following detailed description of the exemplary preferred embodiments taken in conjunction with the accompanying drawings, in which:

FIG. 1 illustrates a perspective view of a system according to an aspect of the present invention;

FIGS. 2A and 2B illustrate front views of systems according to aspects of the present invention; and,

FIG. 3 illustrates a perspective view of a system according to an aspect of the present invention.

### DETAILED DESCRIPTION OF THE INVENTION

It is to be understood that the figures and description of the present invention have been simplified to illustrate elements that are relevant for a clear understanding of the present invention, while eliminating, for purposes of clarity, many other elements found in a typical thermostat system. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure hereinbelow is directed to all such variations and modifications as will be apparent to those skilled in the art.

According to an aspect of the present invention, an operator panel and/or display of a thermostat, and/or a thermostat housing, may be hidden behind, or concealed by, one or more facades that provides for easy thermostat accessibility. According to an aspect of the present invention, interchangeable front facade(s) may be used. The present invention solves the foregoing problems by “hiding in plain view” a conventional, wall-mounted thermostat, thereby not significantly limiting, hindering or adversely affecting a room's décor, and possibly even enhancing it. The term “facade” as used herein refers generally to something that covers or is laid, placed, or spread over or upon something else.

According to an aspect of the present invention, a wall-mounted thermostat system may be provided that has a modular, hinged front facade that allows the thermostat to be hidden and blended in with the room's décor. The facade may be interchangeable or include interchangeable portions, thereby enabling the appearance of the thermostat to be changed from time to time without replacing the entire thermostat, while still allowing an operator, such as a homeowner, to have easy access to the thermostat controls. Thus, a system according to an aspect of the present invention may be considered modular.

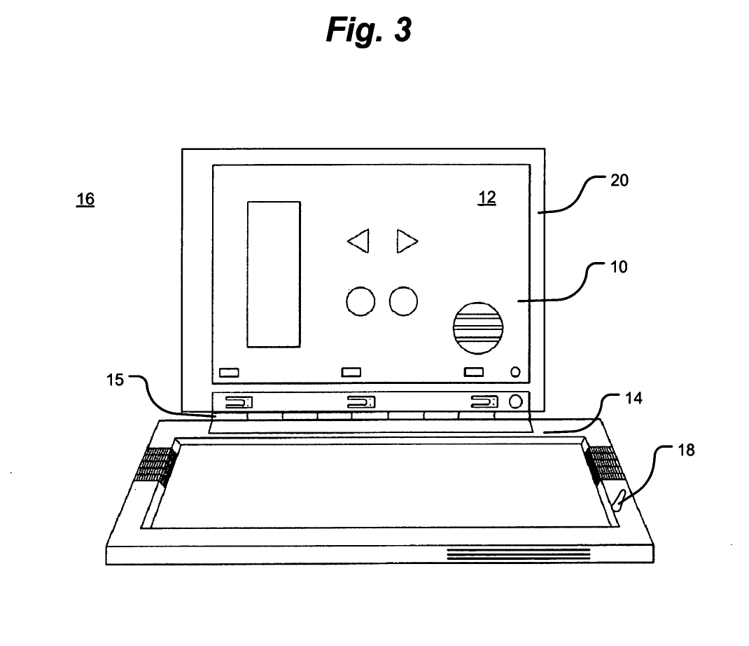

According to an aspect of the present invention, the facade may provide sufficient venting for a concealed thermostat. Such as by leaving a portion of a periphery of the thermostat open or by having venting built into it, such as through the use of apertures, that may be elongated for example on top and bottom edges (see, e.g., FIG. 3). Further, apertures could be included near an outer periphery of the facade. It should be understood however, that as long as sufficient venting allows the thermostat to accurately detect the room temperature, the particulars are not critical.

Additionally, a thermostat system according to the present invention may provide for vandal-resistant features to be added, for instance by including a hidden lock and/or vandal-resistant screws, should a homeowner, tenant or property manager desire to take on added security measures.

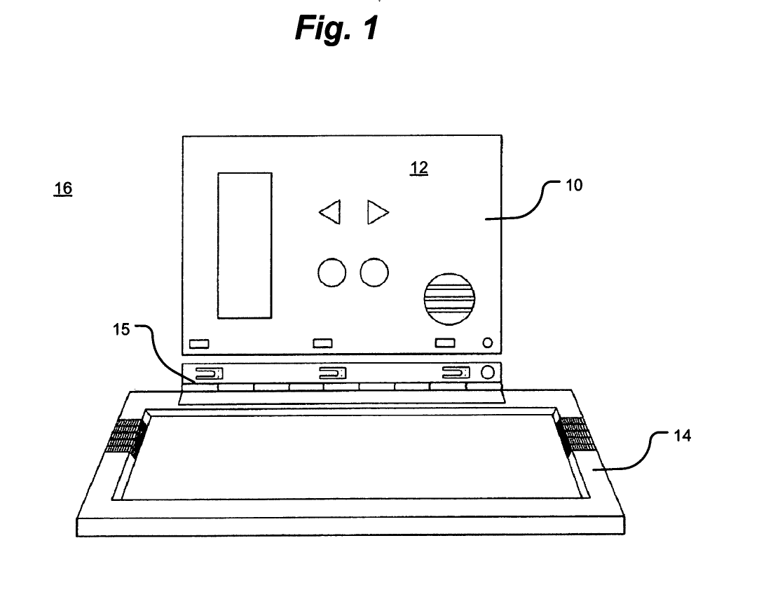

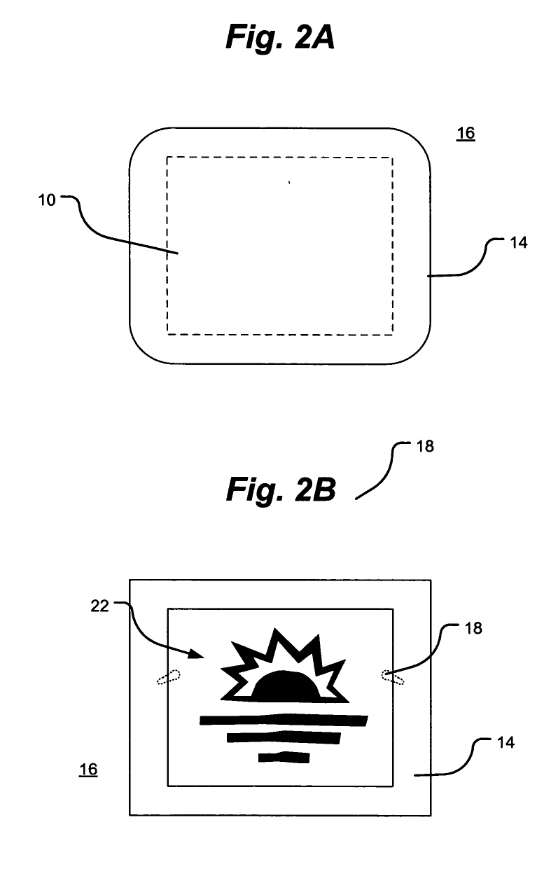

Referring now to FIG. 1, there is shown a perspective view of a modular thermostat system according to an aspect of the present invention. A system according to the present invention includes a facade 14. Facade 14 may be modular. Facade 14 may be securedly positioned in at least two positions. One position facilitates access to a control panel 12 of thermostat 10 (see FIG. 1). Another obscures sight of thermostat 10 (see FIGS. 2A and 2B).

Thermostat 10, which may be of any standard or customized make or design, may be mounted in or on a wall 16 of a room. Thermostat 10 may have variable amounts of protrusion perpendicularly extending from the wall surface. Thermostat 10 may range from fully embedded into wall 16 so that no part of the thermostat breaks the plane of the wall surface, to being mounted on the wall 16 so that thermostat 10 protrudes fully from the wall surface.

Facade 14 may take the form of a cover of any shape, such as a rectangle, circle, or oval. Facade 14 may have square, rounded or beveled edges, also by way of non-limiting example. Referring now also to FIG. 2A, according to an aspect of the present invention, an exterior perimeter of facade 14 may substantially entirely obscure thermostat 10 and hide it from plain sight when in facade 14 is put into an obscuring position.

Referring now also to FIG. 2B, facade 14 may be suitable for displaying images 22, such as drawings, paintings, photographs, signs or any image or visual representation which may fit the dimensions of the modular facade 14, such as in channels thereof for example. According to an aspect of the present invention, facade 14 may largely take the form of a picture frame, that may have pictures inserted there into in a conventional fashion. For example, facade 14 may include an interior portion and stays for securing a picture thereto or therein in a same manner as a conventional picture frame. By way of further non-limiting example only, facade 14 may include rotatable portions 18 (FIGS. 2B and 3) secured to an inner surface thereof. Stays 18 may be suitable for securing a picture within facade 14 (FIG. 2B). Similar to a typical picture frame, facade 14 may include a protective front sheet of plastic or glass, but can also be utilized without any front covering. Facade 14, or a perimeter portion thereof in the case of a picture frame embodiment, may be of any suitable housing material, such as wood, metal or plastic, and, in the case of picture frame embodiment, of any design suitable for decoratively framing or accenting image(s) displayed by the facade 14. Facade 14 may allow for interchangeable front housings, perimeters or inserts, which can be attached in a removable but fixed way to hide the thermostat 10.

The adaptability of facade 14 gives the homeowner or tenant the ability to change the appearance of the facade according to their current decorative desires or needs.

Referring again to FIG. 1, facade 14 may be attached to a wall 16 of a room by any suitable means for allowing access to thermostat 10. For example, hinging 15 that allows for the modular facade 14 to move from a position substantially flush with thermostat 10 to that in which thermostat 10 is exposed may be provided. Hinging 15 allows the homeowner to have easy access to the thermostat controls. The hinging can include single or multiple brackets, which may be placed on any edge of the wall surrounding the thermostat, for example. Referring now also to FIG. 3, the hinging and thus facade 14 may alternatively be secured to a thermostat 10 itself, or a mounting plate 20. Mounting plate 20 may be secured to facade 14 and thermostat 10 and/or wall 16. Thus, facade 14 can swing up or down, or left or right, depending on what edge of the thermostat the facade 14 is mounted.

Alternatively, the facade may be adapted to slide, such as by the use of bosses and channels between a position facilitating access to the thermostat and a position substantially concealing the thermostat.

Hinging 15 may be secured to wall 16, thermostat 10 and/or plate 20 using any suitable means, such as, by way of non-limiting example only, screws, nails, hooks, hangers, velcro brand hook and loop connectors and/or adhesives. Facade 14 and/or mounting plate 20 may include a conventional lock mechanism for restricting access to thermostat 10. A keyhole may be provided on a periphery of facade 14 and/or plate 20.

Referring now to FIGS. 2A and 2B, as discussed facade 14 may serve as a frame for pictures or artwork 22 (FIG. 2B). Alternatively, facade 14 may be substantially uniform or a solid cover and be suitable for being painted and/or having wallpaper attached thereto (FIG. 2A). In this manner, facade 14 may be well suited for being customized to match or complement an interior décor of a room including wall 16. This may serve to help conceal a thermostat when facade 14 is positioned to obscure it as is shown in FIG. 2A. According to an aspect of the present invention, various inserts or substitute frames may be provided, such that each may tend to complement a different décor. By way of non-limiting example only, some may be different colors and/or have different patterns.

It will be apparent to those skilled in the art that various modifications and variations may be made in the system of the present invention without departing from the spirit or scope of the invention. Thus, it is intended that the present invention cover the modification and variations of this invention provided they come within the scope of the appended claims and the equivalents thereof.

1. A facade system for concealing a thermostat housing comprising:
a hinge being selectably positional in at least first and second positions; and,
a cover adapted to be coupled to said hinge;
wherein, when said hinge is positioned substantially adjacent to the thermostat housing and coupled to said cover, said hinge and cover cooperate to facilitate access to the thermostat housing when said hinge is in said first position and to substantially conceal the thermostat housing when said hinge is in said second position.

2. The system of claim 1, wherein said cover forms a frame.

3. The system of claim 2, wherein said frame receives an interchangeable portion.

4. The system of claim 2, wherein said frame includes at least one rotatable member suitable for securing at least one substantially planar member in said frame.

5. The system of claim 1, further comprising at least one aperture in said cover.

6. The system of claim 5, wherein said at least one aperture comprises a plurality of thermostat vents.

7. The system of claim 1, wherein said cover comprises a plurality of rotatable members and a substantially transparent substantially planar member for securing a non-transparent substantially planar member to said cover.

8. The system of claim 1, further comprising a mounting plate secured to said hinge and at least one of said thermostat and a wall.

9. A thermostat system comprising:
a thermostat including a thermostat housing;
a cover adapted to be movably secured substantially adjacent to said housing;
wherein, said cover facilitates access to the thermostat in a first position and substantially conceals the thermostat housing in said second position.

10. The system of claim 9, further comprising a hinge coupled to said cover and suitable for selectively positioning said cover in said first and second positions.

11. The system of claim 10, wherein said cover includes a picture frame.

12. The system of claim 11, wherein said frame receives an interchangeable portion.

13. The system of claim 12, wherein said frame includes at least one rotatable member suitable for securing at least one substantially planar member to said frame.

14. The system of claim 9, further comprising at least one aperture in said cover.

15. The system of claim 14, wherein said at least one aperture comprises a plurality of thermostat vents.

17. The system of claim 9, further comprising a mounting plate secured to said cover and at least one of said thermostat and a wall.

18. The system of claim 9, further comprising means for securing said cover so as to be selectively positional in said first and second positions.
